(19) United States
(12) Patent Application Publication
(10) Pub. No.: US 2020/0293145 A1
(43) Pub. Date: Sep. 17, 2020

(54) TOUCH MODULE

(71) Applicant: Primax Electronics Ltd., Taipei (TW)

(72) Inventors: Chung-Yuan Chen, Taipei (TW); Wei-Ping Chan, Taipei (TW)

(21) Appl. No.: 16/424,118

(22) Filed: May 28, 2019

(30) Foreign Application Priority Data
Mar. 15, 2019 (TW) 108108949

(51) Int. Cl. G06F 3/042; F21V 8/00

(52) U.S. Cl. CPC G06F 3/0421; G02B 6/0091; G02B 6/0041; G02B 6/0068; G02B 6/002; G02B 6/005

(57) ABSTRACT

A touch module for an electronic device is provided. The touch module includes a touch-sensitive plate, a light guide plate, a light-shielding plate and a translucent covering plate. The touch-sensitive plate includes plural light-emitting units. The light guide plate is disposed on the touch-sensitive plate. The light-shielding plate is located over the light guide plate. The light-shielding plate includes a hollow portion. The translucent covering plate is located over the light-shielding plate. The hollow portion is covered by the translucent covering plate. According to a touch signal, the touch-sensitive plate controls the plural light-emitting units to emit light beams to the light guide plate. After the light beams are transmitted through the hollow portion, the light beams are transferred to the translucent covering plate.

### FIELD OF THE INVENTION

The present invention relates to a touch module, and more particularly to a touch module that is installed in an electronic device.

### BACKGROUND OF THE INVENTION

A touch module gradually becomes an essential accessory of an electronic device. The user can operate, enable or disable the electronic device through the touch module. However, the conventional touch module still has some drawbacks. For example, the conventional touch module does not have the function of displaying the operating status of the electronic device. During the operation of the touch module, the user is unable to realize the operating status of the electronic device immediately.

For solving the above drawbacks, it is important to provide a touch module capable of displaying an operating status of an electronic device for allowing the user to realize the current operating status of the electronic device immediately and intuitively.

### SUMMARY OF THE INVENTION

The present invention provides a touch module. The touch module is capable of displaying an operating status of an electronic device for allowing the user to realize the current operating status of the electronic device immediately and intuitively.

In accordance with an aspect of the present invention, a touch module for an electronic device is provided. The touch module includes a touch-sensitive plate, a light guide plate, a light-shielding plate and a translucent covering plate. The touch-sensitive plate includes plural light-emitting units. The light guide plate is disposed on the touch-sensitive plate. The light-shielding plate is located over the light guide plate. The light-shielding plate includes at last one hollow portion. The translucent covering plate is located over the light-shielding plate. The hollow portion is covered by the translucent covering plate. According to a touch signal, the touch-sensitive plate controls the plural light-emitting units to emit light beams to the light guide plate. After the light beams are transmitted through the at last one hollow portion, the light beams are transferred to the translucent covering plate.

In an embodiment, the light guide plate includes a comb-shaped slot and plural light-guiding strips. Moreover, each of the plural light-guiding strips has at least one lateral light-inputting surface.

In an embodiment, the plural light-emitting units are disposed in the comb-shaped slot and aligned with the lateral light-inputting surfaces of the corresponding light-guiding strips. After the light beams from the light-emitting units are received by the lateral light-inputting surfaces of the corresponding light-guiding strips, the light beams are transmitted through the at least one hollow portion. Consequently, the translucent covering plate provides a mixed color pattern.

In an embodiment, plural recesses are formed in a bottom surface of the light guide plate, and the plural light-emitting units are covered by the corresponding recesses.

In an embodiment, the at least one hollow portion includes plural patterned openings, and the plural patterned openings are located over the corresponding light-emitting units.

Preferably, after the light beams are transferred to the light guide plate and transmitted through the at least one hollow portion, the patterned openings are displayed through the translucent covering plate.

In an embodiment, the electronic device is a desktop computer, a notebook computer, a tablet computer, a printer, an office machine, a game console, a keyboard, a mouse, a display screen or a speaker.

In an embodiment, the touch-sensitive plate is operated in a resistive touch control mode, a capacitive touch mode, an electromagnetic touch mode, a sonic touch mode or a pressure sensing touch mode.

In an embodiment, the light-emitting units include light emitting diode units, organic light emitting diode units, quantum dots light emitting diode units or electroluminescence units.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A is a schematic exploded view illustrating a touch module according to a first embodiment of the present invention;

FIG. 1B is a schematic top view illustrating the touch module according to the first embodiment of the present invention;

FIG. 2A is a schematic exploded view illustrating a touch module according to a second embodiment of the present invention;

FIG. 2B is a schematic top view illustrating the touch module according to the second embodiment of the present invention; and

FIG. 2C is a schematic cross-sectional view illustrating the touch module as shown in FIG. 2B and taken along the line A-A′.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

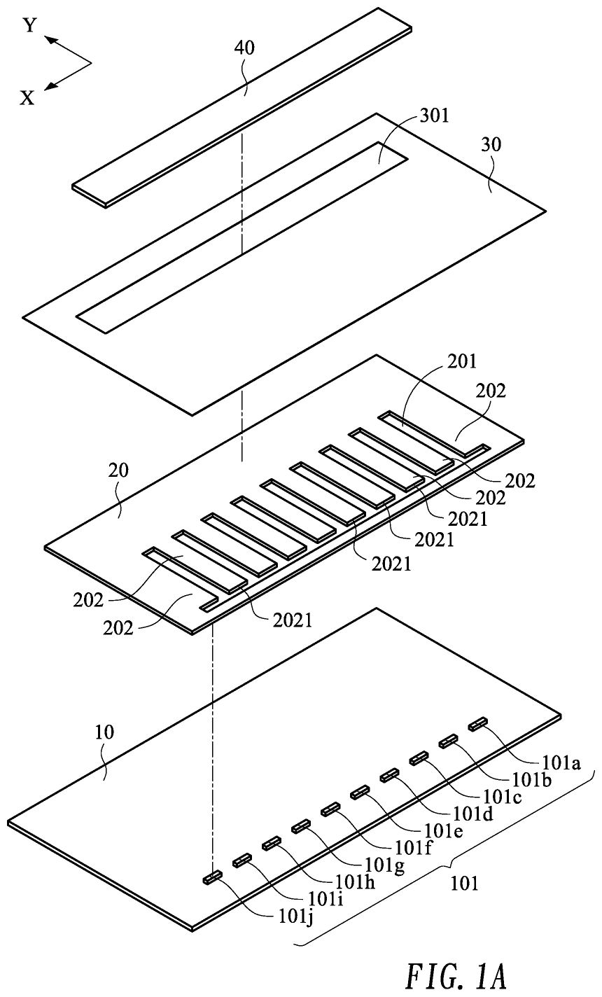

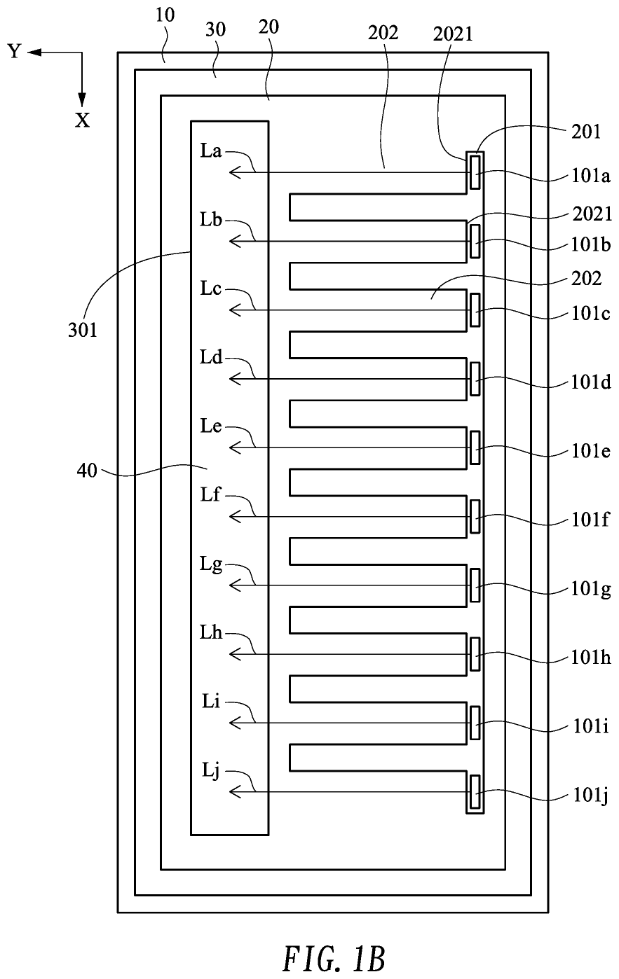

Please refer to FIGS. 1A and 1B. FIG. 1A is a schematic exploded view illustrating a touch module according to a first embodiment of the present invention. FIG. 1B is a schematic top view illustrating the touch module according to the first embodiment of the present invention. For illustration, the two orthogonal axes on the horizontal plane are set as the X axis and the Y axis.

Please refer to FIG. 1A. From top to bottom, the touch module 1 comprises a touch-sensitive plate 10, a light guide plate 20, a light-shielding plate 30 and a translucent covering plate 40.

The touch-sensitive plate 10 comprises a microcontroller unit (MCU) (not shown). Moreover, plural light-emitting units 101 are discretely arranged on a surface of the touch-sensitive plate 10 along the X axis. For example, these light-emitting units 101 include the light-emitting units 101a, 101b, 101c, 101d, 101e, 101f, 101g, 101h, 101i and 101j. Examples of the light-emitting units 101 include but are not limited to light emitting diode units, organic light emitting diode units, quantum dots light emitting diode units or electroluminescence units. According to a touch signal detected by the touch-sensitive plate 10, the light-emitting units 101 sequentially emit light beams with different tones or different luminous intensities, or the light-emitting units 101 sequentially emit light beams with the identical tone but different luminous intensities. The touch-sensitive plate 10 can be operated in a resistive touch control mode, a capacitive touch mode, an electromagnetic touch mode, a sonic touch mode or a pressure sensing touch mode.

The light guide plate 20 is disposed on the touch-sensitive plate 10. The light guide plate 20 is made of polycarbonate (PC), polymethylmethacrylate (PMMA) or any appropriate optical-grade light-guiding plastic material. During the process of fabricating the light guide plate 20, diffusion particles are added to the plastic material in order to increase the brightness of the light guide plate 20. In an embodiment, the light guide plate 20 comprises a comb-shaped slot 201 and plural light-guiding strips 202. The comb-shaped slot 201 run through the light guide plate 20. The plural light-guiding strips 202 are arranged beside the comb-shaped slot 201. Each light-guiding strip 202 has at least one lateral light-inputting surface 2021. The light-emitting units 101 are side-view light-emitting units and disposed in the comb-shaped slot 201. The light-emitting units 101 are aligned with the lateral light-inputting surfaces 2021 of the corresponding light-guiding strips 202. The light beams from the light-emitting units 101 are received by the lateral light-inputting surfaces 2021 of the corresponding light-guiding strips 202.

The light-shielding plate 30 is located over the light guide plate 20. Moreover, the light-shielding plate 30 has a hollow portion 301. The hollow portion 301 is arranged beside the comb-shaped slot 201 and not overlapped with the comb-shaped slot 201.

The translucent covering plate 40 is located over the light-shielding plate 30. In addition, the hollow portion 301 is covered by the translucent covering plate 40. The user's finger can touch or move on the translucent covering plate 40. By detecting the touching or moving condition of the user's finger on the translucent covering plate 40, the touch-sensitive plate 10 generates a corresponding touch signal.

In the embodiment as shown in FIG. 1B, the touch module 1 can be used as a switching key or a control key of an electronic device. For example, the electronic device is a desktop computer, a notebook computer, a tablet computer, a printer, an office machine, a game console, a keyboard, a mouse, a display screen or a speaker. When the user's finger touches the translucent covering plate 40 and moves from top to bottom or from bottom to top along the X axis, the luminous intensity of the display screen (i.e., an example of the electronic device) is gradually increased or decreased, or the sound volume of the speaker (i.e., another example of the electronic device) is gradually increased or decreased. Moreover, according to the touch signal, the touch-sensitive plate 10 controls the light-emitting units 101a˜101j to emit the light beams La˜Lj to the lateral light-inputting surfaces 2021 of the corresponding light-guiding strips 202 sequentially. The light beams La˜Lj are transferred to the corresponding positions of the hollow portion 301 through the corresponding light-guiding strips 202. Consequently, the translucent covering plate 40 produces mixed colors. For example, in case that the tones of the light beams La˜Lj include red, orange, yellow, green, blue, indigo and purple colors, the translucent covering plate 40 produces a rainbow-like mixed color. In case that the tones of the light beams La˜Lj are identical and the luminous intensities of the tones of the light beams La˜Lj is gradually increased, the translucent covering plate 40 produces a gradual mixed color of the colors from dark to bright. Alternatively, the mixed color is a gradual mixed color of the colors with different tones. In this way, the user can observe the mixed color pattern through the translucent covering plate 40 with the naked eyes. According to the mixed color pattern, the user can roughly know the current luminous intensity of the display screen or the sound volume of the speaker.

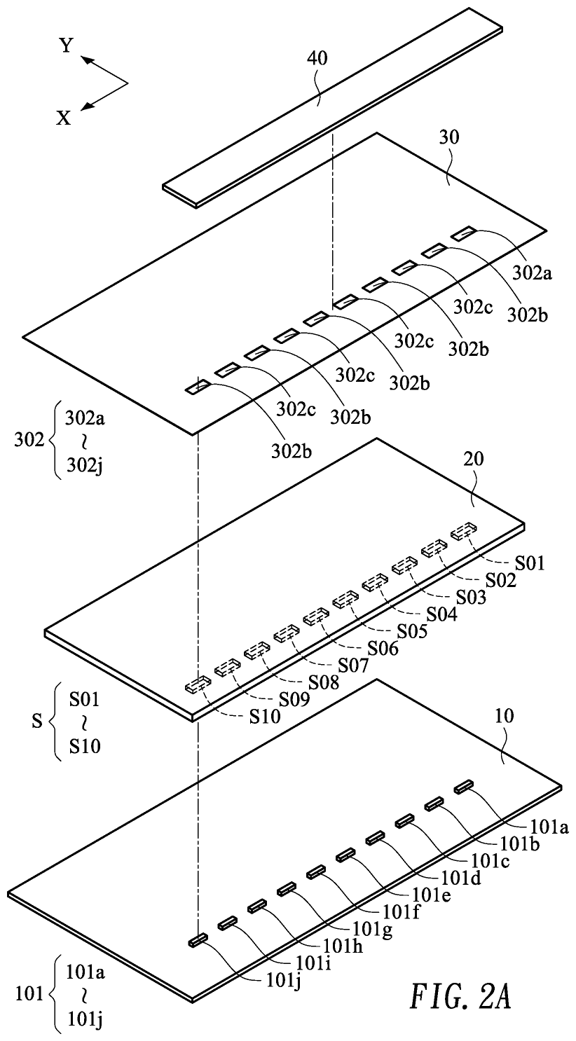

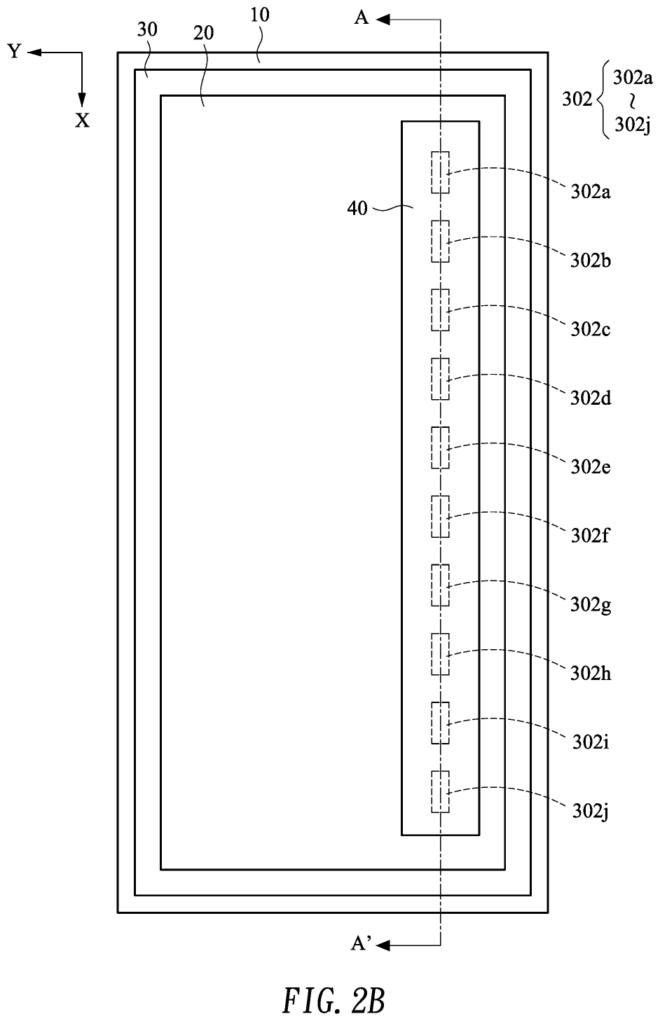

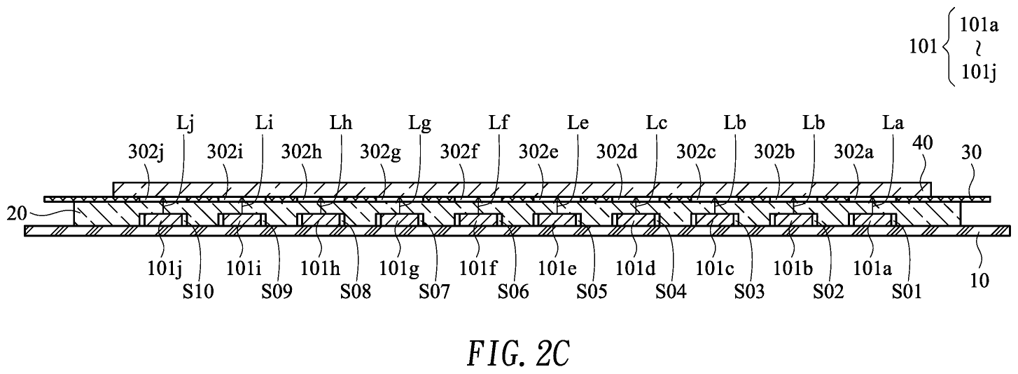

Please refer to FIGS. 2A, 2B and 2C. FIG. 2A is a schematic exploded view illustrating a touch module according to a second embodiment of the present invention. FIG. 2B is a schematic top view illustrating the touch module according to the second embodiment of the present invention. FIG. 2C is a schematic cross-sectional view illustrating the touch module as shown in FIG. 2B and taken along the line A-A′. In this embodiment, the touch module comprises a touch-sensitive plate 10, a light guide plate 20, a light-shielding plate 30 and a translucent covering plate 40. The structures of the touch-sensitive plate 10 and the translucent covering plate 40 are similar to those of the first embodiment, and are not redundantly described herein. Similarly, plural light-emitting units 101 are discretely arranged on a surface of the touch-sensitive plate 10. In this embodiment, the light-emitting units 101 are top-view light-emitting units.

Moreover, plural recesses S are formed in a bottom surface of the light guide plate 20. These recesses S include the recesses S01˜S10. The installation positions of the recesses S01˜S10 are aligned with the light-emitting units 101a˜101j, respectively. The light-emitting units 101a˜101j are accommodated within and covered by the recesses S01˜S10, respectively.

In this embodiment, the hollow portion 302 of the light-shielding plate 30 comprises patterned openings 302a˜302j. These openings 302a˜302j are located over the light-emitting units 101a˜101j, respectively. Each of these patterned openings 302a˜302j has the profile of a picture, a symbol, a text, or the combination thereof.

The translucent covering plate 40 is located over the light-shielding plate 30. In addition, the patterned openings 302a˜302j are covered by the translucent covering plate 40. In case that the light-emitting units 101a˜101j are disabled, the patterned openings 302a˜302j or the optical pattern of the patterned openings 302a˜302j cannot be viewed by the user through the translucent covering plate 40.

Please refer to FIG. 2C. According to the touch signal, the touch-sensitive plate 10 controls the light-emitting units 101a˜101j to emit the light beams La˜Lj upwardly to the light guide plate 20. Then, the light beams La˜Lj are transmitted through the corresponding patterned openings 302a˜302j of the hollow portion 302. Consequently, an optical pattern corresponding to the patterned openings 302a˜302j is displayed through the translucent covering plate 40. When the user's finger touches the translucent covering plate 40 corresponding to any position of the patterned openings 302a˜302j, the electronic function corresponding to the touched position of the patterned openings 302a˜302j is enabled or disabled. For example, the profile of the patterned opening 302a denotes the on/off state of the display screen. When the user's finger touches the translucent covering plate 40 corresponding to the position of the patterned opening 302a, the display screen is turned on. According to the touch signal, the touch-sensitive plate 10 controls the light-emitting unit 101a to emit the light beam La upwardly to the light guide plate 20. Then, the light beam La is transmitted through the hollow portion 302. Consequently, the optical pattern corresponding to the patterned opening 302a is displayed through the translucent covering plate 40. In this way, the user can observe the optical pattern through the translucent covering plate 40 with the naked eyes. According to the optical pattern, the user can realize that the display screen is in the on state. When the user's finger touches the translucent covering plate 40 corresponding to the position of the patterned opening 302a again, the display screen is turned off. According to the touch signal, the touch-sensitive plate 10 controls the light-emitting unit 101a to stop emitting the light beam La upwardly to the light guide plate 20. Consequently, the optical pattern corresponding to the patterned opening 302a is not displayed through the translucent covering plate 40. Meanwhile, the user realizes that the display screen is in the off state.

In the above embodiments, the mixed color pattern or the optical pattern is displayed through the translucent covering plate 40. It is noted that numerous modifications and alterations may be made while retaining the teachings of the invention. For example, in another embodiment, the combination of the mixed color pattern and the optical pattern can be displayed through the translucent covering plate 40.

From the above descriptions, the present invention provides the touch module. The touch module is capable of providing the mixed color pattern or the optical pattern for allowing the use to intuitively and roughly realize the current operating status of the electronic device. Consequently, the electronic device is more user-friendly. Moreover, since the touch module provides the color-changeable pattern or the optical pattern, the appearance of the electronic device is aesthetically pleasing. In other words, the touch module of the present invention is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A touch module for an electronic device, the touch module comprising:
a touch-sensitive plate comprising plural light-emitting units;
a light guide plate disposed on the touch-sensitive plate;
a light-shielding plate located over the light guide plate, wherein the light-shielding plate comprises at last one hollow portion; and
a translucent covering plate located over the light-shielding plate, wherein the hollow portion is covered by the translucent covering plate,
wherein according to a touch signal, the touch-sensitive plate controls the plural light-emitting units to emit light beams to the light guide plate, wherein after the light beams are transmitted through the at last one hollow portion, the light beams are transferred to the translucent covering plate.

2. The touch module according to claim 1, wherein the light guide plate comprises a comb-shaped slot and plural light-guiding strips, wherein each of the plural light-guiding strips has at least one lateral light-inputting surface.

3. The touch module according to claim 2, wherein the plural light-emitting units are disposed in the comb-shaped slot and aligned with the lateral light-inputting surfaces of the corresponding light-guiding strips, wherein after the light beams from the light-emitting units are received by the lateral light-inputting surfaces of the corresponding light-guiding strips, the light beams are transmitted through the at least one hollow portion, so that the translucent covering plate provides a mixed color pattern.

4. The touch module according to claim 1, wherein plural recesses are formed in a bottom surface of the light guide plate, and the plural light-emitting units are covered by the corresponding recesses.

5. The touch module according to claim 4, wherein the at least one hollow portion includes plural patterned openings, and the plural patterned openings are located over the corresponding light-emitting units.

6. The touch module according to claim 5, wherein after the light beams are transferred to the light guide plate and transmitted through the at least one hollow portion, the patterned openings are displayed through the translucent covering plate.

7. The touch module according to claim 1, wherein the electronic device is a desktop computer, a notebook computer, a tablet computer, a printer, an office machine, a game console, a keyboard, a mouse, a display screen or a speaker.

8. The touch module according to claim 1, wherein the touch-sensitive plate is operated in a resistive touch control mode, a capacitive touch mode, an electromagnetic touch mode, a sonic touch mode or a pressure sensing touch mode.

9. The touch module according to claim 1, wherein the light-emitting units include light emitting diode units, organic light emitting diode units, quantum dots light emitting diode units or electroluminescence units.
